(19) United States
(12) Patent Application Publication
(10) Pub. No.: US 2013/0179373 A1
(43) Pub. Date: Jul. 11, 2013

(54) Systems and Methods for Estimating HVAC Operation Cost

(71) Applicant: Trane International Inc., Piscataway, NJ (US)

(72) Inventors: Karl Mutchnik, Tyler, TX (US); Joseph George Land, III, Tyler, TX (US); Kevin B. Mercer, Danville, IN (US); Yi Hu, Tyler, TX (US)

(73) Assignee: TRANE INTERNATIONAL INC., Piscataway, NJ (US)

(21) Appl. No.: 13/734,675

(22) Filed: Jan. 4, 2013

Related U.S. Application Data
(60) Provisional application No. 61/583,832, filed on Jan. 6, 2012.

(51) Int. Cl. G06Q 30/02; F24F 11/00

(52) U.S. Cl. CPC G06Q 30/0283; F24F 11/0001
USPC 705/412; 700/276

(57) ABSTRACT

A method of estimating a cost of operating a heating, ventilation, and/or air conditioning (HVAC) system includes receiving HVAC system information, generating at least one of an HVAC system energy consumption estimate and an HVAC system operation cost estimate as a function of the HVAC system information and a thermodynamic model of at least a portion of the HVAC system, and presenting at least one of the HVAC system energy consumption estimate and the HVAC system operation cost estimate.

### CROSS-REFERENCE TO RELATED APPLICATIONS

The present application claims priority to U.S. Provisional Patent Application No. 61/583,832, filed on Jan. 6, 2012 by Karl Mutchnik, et al., entitled “HVAC Energy Estimator,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Heating, ventilation, and/or air conditioning (HVAC) systems may consume a large amount of energy, relative to other building systems, and changes in HVAC system configuration may affect energy consumed by an HVAC system.

### SUMMARY

In some embodiments of the disclosure, a method is disclosed as comprising receiving HVAC system information, generating at least one of an HVAC system energy consumption estimate and an HVAC system operation cost estimate as a function of the HVAC system information and a thermodynamic model of at least a portion of the HVAC system, and presenting at least one of the HVAC system energy consumption estimate and the HVAC system operation cost estimate.

In other embodiments of the disclosure, a heating, ventilation, and/or air conditioning (HVAC) system is disclosed as comprising a system controller configured to monitor HVAC system information and environmental conditions associated with operating the HVAC system, wherein the system controller is configured to generate an HVAC system operation cost estimate as a function of the HVAC system information, the environmental conditions, and a thermodynamic model of the HVAC system.

In yet other embodiments of the disclosure, a system controller for a heating, ventilation, and/or air conditioning (HVAC) system is disclosed wherein the system controller is configured to generate an HVAC system instantaneous power consumption as a function of HVAC system information and a thermodynamic model of the HVAC system.

### BRIEF DESCRIPTION OF THE DRAWINGS

FIG. 1 is a schematic diagram of an HVAC system according to an embodiment of the disclosure;

FIG. 2 is a simplified schematic diagram of the air circulation paths of the HVAC system of FIG. 1;

FIG. 3 is a flowchart of a method of estimating an operation cost of an HVAC system according to an embodiment of the disclosure;

FIG. 4 is a graphical user interface associated with estimating an HVAC system cooling and heating mode operation cost estimate according to an embodiment of the disclosure;

FIG. 5 is a graphical user interface associated with displaying a summary of HVAC system operation cost estimates according to an embodiment of the disclosure;

FIG. 6 is a graphical user interface associated with comparing summaries of HVAC system operation cost estimates according to an embodiment of the disclosure;

FIG. 7 is a flowchart of a method 1100 of calculating an HVAC system estimated operation cost according to an embodiment of the disclosure;

FIG. 8 is an example chart of monitored and/or calculated values according to an embodiment of the disclosure; and

FIG. 9 is a simplified representation of a general-purpose processor (e.g. electronic controller or computer) system suitable for implementing the embodiments of the disclosure.

### DETAILED DESCRIPTION

This disclosure provides, in some embodiments, systems and methods for (1) estimating HVAC system energy usage based on system components characteristics, system run-time inputs (compressor and/or fan run-times), and system environment characteristics (indoor/outdoor temperatures and humidity), (2) comparing system performance to performance of an ideal or virtual system, and (3) comparing estimated system performance to proposed system performance in view of changing system component characteristics and/or system operation settings. In some embodiments, the estimated energy may be converted to an estimated energy cost. In some embodiments the tool may interactively receive inputs regarding the HVAC system equipment and historical HVAC system performance information (such as compressor run-time and environmental factors). In some embodiments, comparative cost information allows a user or the system to determine whether the HVAC system is operating as intended. Further, the tool may present information to a user that allows cost comparisons between alternative configurations and/or operational settings for the HVAC system. In some embodiments, rather than directly associating an energy consumption rate to a component of an HVAC system, various HVAC system and environmental characteristics may be used to calculate an estimated rate of energy consumptions for a particular component of an HVAC system. Most generally, in some embodiments, energy consumption and/or energy costs may be associated with HVAC systems and/or HVAC system components by utilizing simulations, calculation models, equations, and/or any other means suitable for providing evaluation of substantially the entirety of the HVAC system in the context of the environment in which it is operating or is proposed to operate.

In some embodiments, the HVAC system and/or components thereof may be analyzed for their energy consumption by performing HVAC system analysis calculations and/or by performing HVAC system analysis modeling. In some embodiments, the HVAC system analysis calculations and/or HVAC system analysis modeling may comprise use of equations related to the first, second, and/or third laws of thermodynamics, heat balance equations, and/or any other equations related to modeling HVAC, refrigeration, and/or heating systems. In some embodiments, the energy consumption and/or energy costs may be calculated by HVAC system level analysis rather than simply assigning an energy consumption rate to components and tracking run-time of those same components. However, in some embodiments, simply assigning an energy consumption rate to components and tracking run-time of those same components may be used in addition to and/or instead of HVAC system level analysis.

In some embodiments, a thermostat or other control device may be associated with an HVAC system and may be in selective communication with an HVAC energy consumption calculation server. In some embodiments, a user may input one or more system inputs related to characteristics of the structure associated with the HVAC system, the HVAC system itself, location of the HVAC system, and/or price of electricity and/or fuels consumed by the HVAC system. In some embodiments, the thermostat may collect information about HVAC system operation and/or environmental information. In some embodiments, information inputted and/or collected may be transmitted to the HVAC energy consumption calculation server to enable the HVAC energy consumption calculation server to calculate HVAC system energy consumption and/or HVAC energy cost results. In alternative embodiments, a thermostat or other controller may perform the functions of the above-described thermostat and/or controller as well as the HVAC system energy consumption calculation server.

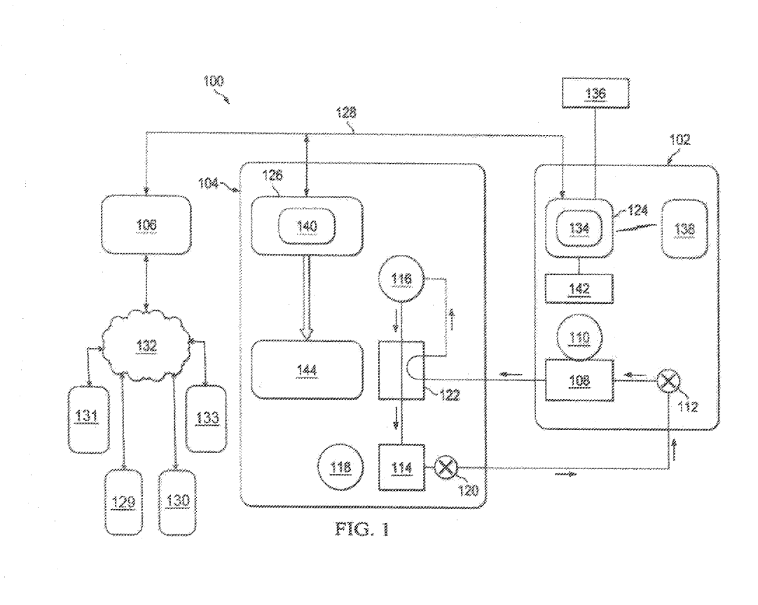

Referring now to FIG. 1, a schematic diagram of an HVAC system 100 according to an embodiment of this disclosure is shown. HVAC system 100 comprises an indoor unit 102, an outdoor unit 104, and a system controller 106. In some embodiments, the system controller 106 may operate to control operation of the indoor unit 102 and/or the outdoor unit 104. As shown, the HVAC system 100 is a so-called heat pump system that may be selectively operated to implement one or more substantially closed thermodynamic refrigeration cycles to provide a cooling functionality and/or a heating functionality. In alternative embodiments, the HVAC system 100 may comprise a type of air-conditioning system that is not a heat pump system.

Indoor unit 102 comprises an indoor heat exchanger 108, an indoor fan 110, and an indoor metering device 112. Indoor heat exchanger 108 is a plate fin heat exchanger configured to allow heat exchange between refrigerant carried within internal tubing of the indoor heat exchanger 108 and fluids that contact the indoor heat exchanger 108 but that are kept segregated from the refrigerant. In other embodiments, indoor heat exchanger 108 may comprise a spine fin heat exchanger, a microchannel heat exchanger, or any other suitable type of heat exchanger.

The indoor fan 110 is a centrifugal blower comprising a blower housing, a blower impeller at least partially disposed within the blower housing, and a blower motor configured to selectively rotate the blower impeller. In other embodiments, the indoor fan 110 may comprise a mixed-flow fan and/or any other suitable type of fan. The indoor fan 110 is configured as a modulating and/or variable speed fan capable of being operated at many speeds over one or more ranges of speeds. In other embodiments, the indoor fan 110 may be configured as a multiple speed fan capable of being operated at a plurality of operating speeds by selectively electrically powering different ones of multiple electromagnetic windings of a motor of the indoor fan 110. In yet other embodiments, the indoor fan 110 may be a single speed fan.

The indoor metering device 112 is an electronically controlled motor driven electronic expansion valve (EEV). In alternative embodiments, the indoor metering device 112 may comprise a thermostatic expansion valve, a capillary tube assembly, and/or any other suitable metering device. The indoor metering device 112 may comprise and/or be associated with a refrigerant check valve and/or refrigerant bypass for use when a direction of refrigerant flow through the indoor metering device 112 is such that the indoor metering device 112 is not intended to meter or otherwise substantially restrict flow of the refrigerant through the indoor metering device 112.

Outdoor unit 104 comprises an outdoor heat exchanger 114, a compressor 116, an outdoor fan 118, an outdoor metering device 120, and a reversing valve 122. Outdoor heat exchanger 114 is a spine fin heat exchanger configured to allow heat exchange between refrigerant carried within internal passages of the outdoor heat exchanger 114 and fluids that contact the outdoor heat exchanger 114 but that are kept segregated from the refrigerant. In other embodiments, outdoor heat exchanger 114 may comprise a plate fin heat exchanger, a microchannel heat exchanger, or any other suitable type of heat exchanger.

The compressor 116 is a multiple speed scroll type compressor configured to selectively pump refrigerant at a plurality of mass flow rates. In alternative embodiments, the compressor 116 may comprise a modulating compressor capable of operation over one or more speed ranges, the compressor 116 may comprise a reciprocating type compressor, the compressor 116 may be a single speed compressor, and/or the compressor 116 may comprise any other suitable refrigerant compressor and/or refrigerant pump.

The outdoor fan 118 is an axial fan comprising a fan blade assembly and fan motor configured to selectively rotate the fan blade assembly. In other embodiments, the outdoor fan 118 may comprise a mixed-flow fan, a centrifugal blower, and/or any other suitable type of fan and/or blower. The outdoor fan 118 is configured as a modulating and/or variable speed fan capable of being operated at many speeds over one or more ranges of speeds. In other embodiments, the outdoor fan 118 may be configured as a multiple speed fan capable of being operated at a plurality of operating speeds by selectively electrically powering different ones of multiple electromagnetic windings of a motor of the outdoor fan 118. In yet other embodiments, the outdoor fan 118 may be a single speed fan.

The outdoor metering device 120 is a thermostatic expansion valve. In alternative embodiments, the outdoor metering device 120 may comprise an electronically controlled motor driven EEV, a capillary tube assembly, and/or any other suitable metering device. The outdoor metering device 120 may comprise and/or be associated with a refrigerant check valve and/or refrigerant bypass for use when a direction of refrigerant flow through the outdoor metering device 120 is such that the outdoor metering device 120 is not intended to meter or otherwise substantially restrict flow of the refrigerant through the outdoor metering device 120.

The reversing valve 122 is a so-called four-way reversing valve. The reversing valve 122 may be selectively controlled to alter a flow path of refrigerant in the HVAC system 100 as described in greater detail below. The reversing valve 122 may comprise an electrical solenoid or other device configured to selectively move a component of the reversing valve 122 between operational positions.

The system controller 106 may comprise a touchscreen interface for displaying information and for receiving user inputs. The system controller 106 may display information related to the operation of the HVAC system 100 and may receive user inputs related to operation of the HVAC system 100. However, the system controller 106 may further be operable to display information and receive user inputs tangentially and/or unrelated to operation of the HVAC system 100. In some embodiments, the system controller 106 may comprise a temperature sensor and may further be configured to control heating and/or cooling of zones associated with the HVAC system 100. In some embodiments, the system controller 106 may be configured as a thermostat for controlling supply of conditioned air to zones associated with the HVAC system.

In some embodiments, the system controller 106 may selectively communicate with an indoor controller 124 of the indoor unit 102, with an outdoor controller 126 of the outdoor unit 104, and/or with other components of the HVAC system 100. In some embodiments, the system controller 106 may be configured for selective bidirectional communication over a communication bus 128. In some embodiments, portions of the communication bus 128 may comprise a three-wire connection suitable for communicating messages between the system controller 106 and one or more of the HVAC system 100 components configured for interfacing with the communication bus 128. Still further, the system controller 106 may be configured to selectively communicate with HVAC system 100 components and/or other device 130 via a communication network 132. In some embodiments, the communication network 132 may comprise a telephone network and the other device 130 may comprise a telephone. In some embodiments, the communication network 132 may comprise the Internet and the other device 130 may comprise a so-called smartphone and/or other Internet enabled mobile telecommunication device.

The indoor controller 124 may be carried by the indoor unit 102 and may be configured to receive information inputs, transmit information outputs, and otherwise communicate with the system controller 106, the outdoor controller 126, and/or any other device via the communication bus 128 and/or any other suitable medium of communication. In some embodiments, the indoor controller 124 may be configured to communicate with an indoor personality module 134, receive information related to a speed of the indoor fan 110, transmit a control output to an electric heat relay, transmit information regarding an indoor fan 110 volumetric flow-rate, communicate with and/or otherwise affect control over an air cleaner 136, and communicate with an indoor EEV controller 138. In some embodiments, the indoor controller 124 may be configured to communicate with an indoor fan controller 142 and/or otherwise affect control over operation of the indoor fan 110. In some embodiments, the indoor personality module 134, or any other suitable information storage device, may comprise information related to the identification and/or operation of the indoor unit 102 and/or a position of the outdoor metering device 120.

In some embodiments, the indoor EEV controller 138 may be configured to receive information regarding temperatures and pressures of the refrigerant in the indoor unit 102. More specifically, the indoor EEV controller 138 may be configured to receive information regarding temperatures and pressures of refrigerant entering, exiting, and/or within the indoor heat exchanger 108. Further, the indoor EEV controller 138 may be configured to communicate with the indoor metering device 112 and/or otherwise affect control over the indoor metering device 112.

The outdoor controller 126 may be carried by the outdoor unit 104 and may be configured to receive information inputs, transmit information outputs, and otherwise communicate with the system controller 106, the indoor controller 124, and/or any other device via the communication bus 128 and/or any other suitable medium of communication. In some embodiments, the outdoor controller 126 may be configured to communicate with an outdoor personality module 140 that may comprise information related to the identification and/or operation of the outdoor unit 104. In some embodiments, the outdoor controller 126 may be configured to receive information related to an ambient temperature associated with the outdoor unit 104, information related to a temperature of the outdoor heat exchanger 114, and/or information related to refrigerant temperatures and/or pressures of refrigerant entering, exiting, and/or within the outdoor heat exchanger 114 and/or the compressor 116. In some embodiments, the outdoor controller 126 may be configured to transmit information related to monitoring, communicating with, and/or otherwise affecting control over the outdoor fan 118, a compressor sump heater, a solenoid of the reversing valve 122, a relay associated with adjusting and/or monitoring a refrigerant charge of the HVAC system 100, a position of the indoor metering device 112, and/or a position of the outdoor metering device 120. The outdoor controller 126 may further be configured to communicate with a compressor drive controller 144 that is configured to electrically power and/or control the compressor 116.

The HVAC system 100 is shown configured for operating in a so-called cooling mode in which heat is absorbed by refrigerant at the indoor heat exchanger 108 and heat is rejected from the refrigerant at the outdoor heat exchanger 114. In some embodiments, the compressor 116 may be operated to compress refrigerant and pump the relatively high temperature and high pressure compressed refrigerant from the compressor 116 to the outdoor heat exchanger 114 through the reversing valve 122 and to the outdoor heat exchanger 114. As the refrigerant is passed through the outdoor heat exchanger 114, the outdoor fan 118 may be operated to move air into contact with the outdoor heat exchanger 114, thereby transferring heat from the refrigerant to the air surrounding the outdoor heat exchanger 114. The refrigerant may primarily comprise liquid phase refrigerant and the refrigerant may be pumped from the outdoor heat exchanger 114 to the indoor metering device 112 through and/or around the outdoor metering device 120 which does not substantially impede flow of the refrigerant in the cooling mode. The indoor metering device 112 may meter passage of the refrigerant through the indoor metering device 112 so that the refrigerant downstream of the indoor metering device 112 is at a lower pressure than the refrigerant upstream of the indoor metering device 112. The pressure differential across the indoor metering device 112 allows the refrigerant downstream of the indoor metering device 112 to expand and/or at least partially convert to gaseous phase. The gaseous phase refrigerant may enter the indoor heat exchanger 108. As the refrigerant is passed through the indoor heat exchanger 108, the indoor fan 110 may be operated to move air into contact with the indoor heat exchanger 108, thereby transferring heat to the refrigerant from the air surrounding the indoor heat exchanger 108. The refrigerant may thereafter reenter the compressor 116 after passing through the reversing valve 122.

To operate the HVAC system 100 in the so-called heating mode, the reversing valve 122 may be controlled to alter the flow path of the refrigerant, the indoor metering device 112 may be disabled and/or bypassed, and the outdoor metering device 120 may be enabled. In the heating mode, refrigerant may flow from the compressor 116 to the indoor heat exchanger 108 through the reversing valve 122, the refrigerant may be substantially unaffected by the indoor metering device 112, the refrigerant may experience a pressure differential across the outdoor metering device 120, the refrigerant may pass through the outdoor heat exchanger 114, and the refrigerant may reenter the compressor 116 after passing through the reversing valve 122. Most generally, operation of the HVAC system 100 in the heating mode reverses the roles of the indoor heat exchanger 108 and the outdoor heat exchanger 114 as compared to their operation in the cooling mode.

Still further, the system controller 106 may be configured to selectively communicate with other systems via the communication network 132. In some embodiments, the system controller 106 may communicate with weather data providers (WDPs) 133, such as the National Weather Service, The Weather Channel, and Weather Underground which may provide weather data via the network 132. In some embodiments, the system controller 106 may communicate with a customized data providers (CDPs) 131, such as home automation service provider authorized by the manufacturer of system controller 106, which may provide weather data specifically formatted for use by system controllers 106. In this case, the CDP 131 may be designed or authorized by the system controller 106 manufacturer to store data such as a location of an HVAC system 100 installation, HVAC system 100 model number, HVAC system 100 serial number, and/or other HVAC system 100 data for system controllers 106. Such data may further comprise details on the installation of the HVAC system 100, including features of the buildings, energy suppliers, and physical sites. Such data may be provided by any of the HVAC system 100 owner, the HVAC system 100 installer, the HVAC system 100 distributor, the HVAC system 100 manufacturer, and/or any other entity associated with the manufacture, distribution, purchase, and/or installation of HVAC system 100.

The CDP 131 may also collect, process, store, and/or redistribute information supplied from system controllers 106. Such information may comprise HVAC system 100 service data, HVAC system 100 repair data, HVAC system 100 malfunction alerts, HVAC system 100 operational characteristics, measurements of weather conditions local to the HVAC system 100, energy cost data, HVAC system 100 run times, and/or any other information available to the system controller 106.

CDP 131 may also be configured to gather data from the WDPs 133 and communicate with other devices 130, such as, telephones, smart phones, tablets, and/or personal computers. CDP 131 may also, for example, collect energy cost data from another web site and provide the energy cost data to system controller 106. CDP 131 may be controlled and operated by any entity authorized to communicate with system controller 106. Authorization for access to system controller 106 may take the form of a password, encryption, and/or any other suitable authentication method. Optionally, authorization may be disabled using system controller 106.

CDP 131 may be configured to allow for the setup of account login information to remotely configure system controller 106. For example, the CDP 131 may provide the user using an opportunity to configure system controller 106 with a large general purpose computer screen and greater number of interface features than may be available on a user interface of system controller 106, in some cases, allowing the interface of system controller 106 to be smaller and/or eliminated entirely.

System controller 106 may also be configured to communicate with other Internet sites 129. Such other data providers (ODPs) 129 may provide current time and/or energy cost data of the energy suppliers for HVAC system 100. For example, system controller 106 may communicate with a local energy provider to retrieve current energy cost data.

The weather data provided by WDPs 133 may comprise one or more of: temperatures, solar conditions, sunrise times, sunset times, dew point temperatures, wind chill factors, average wind speeds, wind speed ranges, maximum wind speeds, wind directions, relative humidity, snow, rain, sleet, hail, barometric pressure, heat index, air quality, air pollution, air particulates, ozone, pollen counts, fog, cloud cover, and/or any other available atmospheric and/or meteorological variable that may affect energy consumption of the HVAC system 100. The weather data may be retrieved for intervals that span a year, a month, ten days, a week, a day, 4 hours, 2 hours, one hour, a quarter hour, and/or another available interval.

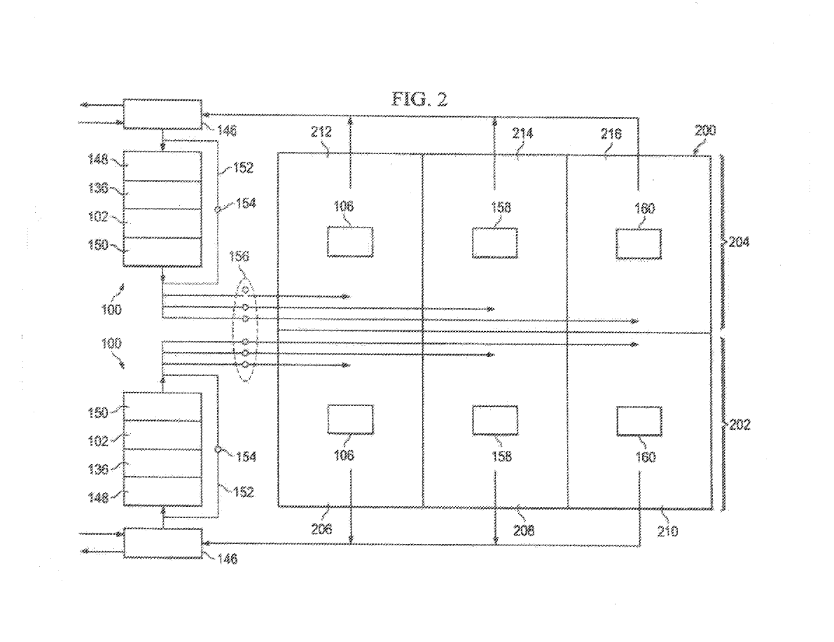

Referring now to FIG. 2, a simplified schematic diagram of the air circulation paths for a structure 200 conditioned by two HVAC systems 100 is shown. In this embodiment, the structure 200 is conceptualized as comprising a lower floor 202 and an upper floor 204. The lower floor 202 comprises zones 206, 208, and 210 while the upper floor 204 comprises zones 212, 214, and 216. The HVAC system 100 associated with the lower floor 202 is configured to circulate and/or condition air of lower zones 206, 208, and 210 while the HVAC system 100 associated with the upper floor 204 is configured to circulate and/or condition air of upper zones 212, 214, and 216.

In addition to the components of HVAC system 100 described above, in this embodiment, each HVAC system 100 further comprises a ventilator 146, a prefilter 148, a humidifier 150, and a bypass duct 152. The ventilator 146 may be operated to selectively exhaust circulating air to the environment and/or introduce environmental air into the circulating air. The prefilter 148 may generally comprise a filter media selected to catch and/or retain relatively large particulate matter prior to air exiting the prefilter 148 and entering the air cleaner 136. The humidifier 150 may be operated to adjust a humidity of the circulating air. The bypass duct 152 may be utilized to regulate air pressures within the ducts that form the circulating air flow paths. In some embodiments, air flow through the bypass duct 152 may be regulated by a bypass damper 154 while air flow delivered to the zones 206, 208, 210, 212, 214, and 216 may be regulated by zone dampers 156.

Still further, each HVAC system 100 may further comprise a zone thermostat 158 and a zone sensor 160. In some embodiments, a zone thermostat 158 may communicate with the system controller 106 and may allow a user to control a temperature, humidity, and/or other environmental setting for the zone in which the zone thermostat 158 is located. Further, the zone thermostat 158 may communicate with the system controller 106 to provide temperature, humidity, and/or other environmental feedback regarding the zone in which the zone thermostat 158 is located. In some embodiments, a zone sensor 160 may communicate with the system controller 106 to provide temperature, humidity, and/or other environmental feedback regarding the zone in which the zone sensor 160 is located. compare

While HVAC systems 100 are shown as a so-called split system comprising an indoor unit 102 located separately from the outdoor unit 104, alternative embodiments of an HVAC system 100 may comprise a so-called package system in which one or more of the components of the indoor unit 102 and one or more of the components of the outdoor unit 104 are carried together in a common housing or package. The HVAC system 100 is shown as a so-called ducted system where the indoor unit 102 is located remote from the conditioned zones, thereby requiring air ducts to route the circulating air. However, in alternative embodiments, an HVAC system 100 may be configured as a non-ducted system in which the indoor unit 102 and/or multiple indoor units 102 associated with an outdoor unit 104 is located substantially in the space and/or zone to be conditioned by the respective indoor units 102, thereby not requiring air ducts to route the air conditioned by the indoor units 102.

Still referring to FIG. 2, the system controllers 106 may be configured for bidirectional communication with each other and may further be configured so that a user may, using any of the system controllers 106, monitor and/or control any of the HVAC system 100 components regardless of which zones the components may be associated. Further, each system controller 106, each zone thermostat 158, and each zone sensor 160 may comprise a humidity sensor. As such, it will be appreciated that structure 200 is equipped with a plurality of humidity sensors in a plurality of different locations. In some embodiments, a user may effectively select which of the plurality of humidity sensors is used to control operation of one or more of the HVAC systems 100.

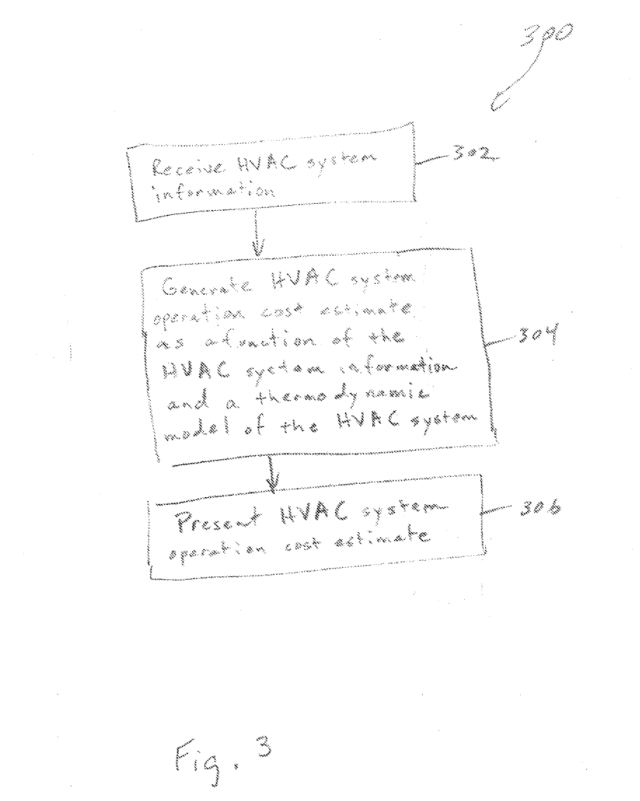

Referring now to FIG. 3, a flowchart of a method 300 of providing HVAC operation cost is shown. The method 300 may begin at block 302 by receiving HVAC system 100 information that is necessary to establish and/or utilize a thermodynamic model of the HVAC system 100 and/or the environment in which the HVAC system 100 is located and/or operating. Next, at block 304, the method 300 may utilize the above-described received HVAC system 100 information to generate an HVAC system 100 operation cost estimate as a function of the HVAC system 100 information and a thermodynamic model of the HVAC system.

The operation cost estimate may be predicated on a simplified, moderately detailed, or very detailed thermodynamic model of the HVAC system 100. Most generally, thermodynamic models of HVAC systems may utilize any of the rated tonnage of the HVAC system, the rated Seasonal Energy Efficiency Rating (SEER) or Energy Efficiency Rating (EER) of the HVAC system, Heating and Seasonal Performance Factor (HSPF) of the HVAC system, rated furnace efficiency, rated furnace capacity, indoor fan capacity, indoor temperature settings, duct work design, and/or any other suitable HVAC system characteristics. In some embodiments, generating the operation cost estimate may comprise utilizing a rated capacity of the HVAC system 100 and an assumption that the HVAC system 100 is correctly capacitively matched to the structure 200. Further, because systematic errors present in the first consumption estimate may also appear in a second consumption estimate, the systematic errors may cancel each other out when comparing a first consumption estimate to a second consumption estimate. Similarly, systemic errors may cancel each other out when comparing a first projected cost to a second projected cost. The operation cost estimate may be based on data related to other structures substantially similar to structure 200. HVAC equipment substantially similar to HVAC system 100 may be monitored and data may be collected that links energy consumption to weather conditions. The system controller 106 may select a closest match of data from monitoring other structures for use in generating an operation cost estimate.

In some embodiments, the HVAC system 100 and/or components thereof may be analyzed for their energy consumption by performing HVAC system 100 analysis calculations and/or by performing HVAC system 100 analysis modeling. In some embodiments, the HVAC system 100 analysis calculations and/or HVAC system 100 analysis modeling may comprise use of equations related to the first, second, and/or third laws of thermodynamics, heat balance equations, and/or any other equations related to modeling HVAC, refrigeration, and/or heating systems. In some embodiments, the energy consumption and/or energy costs may be calculated by HVAC system level analysis rather than simply assigning an energy consumption rate to components and tracking run-time of those same components. However, in some embodiments, simply assigning an energy consumption rate to components and tracking run-time of those same components may be used in addition to and/or instead of HVAC system level analysis.

In some embodiments, cooling mode thermodynamic modeling of the HVAC system 100 may be performed according to widely accepted technical references that provide industry standard calculations regarding the particular HVAC system 100 components. For example, when HVAC system comprises a single-speed electric DX air cooling coil, the thermal performance of the DX cooling coil may be modeled with reference to the equations set out on pages 565-592 of the EnergyPlus Engineering Reference, published by the Board of Trustees of the University of Illinois and the Regents of the University of California through the Ernest Orlando Lawrence Berkeley National Laboratory (2011), which is hereby incorporated by reference in its entirety. In some embodiments, engineering equations could be used to predict the instantaneous capacity and instantaneous EER of HVAC system 100. Instantaneous power may be defined as the instantaneous capacity divided by the instantaneous EER. HVAC system 100 characteristics and HVAC system 100 component characteristics may be utilized to provide HVAC energy consumption and/or HVAC energy cost calculations more accurately. The fan operating curves, compressor operating curves, and system performance curves may provide performance characteristic information that depend on temperatures (indoor ambient and/or outdoor ambient), air pressures, humidity, and/or any other factor that may alter performance of the HVAC system and/or its components.

The engineering equations utilized to determine an instantaneous capacity, instantaneous EER, and/or instantaneous power of the HVAC system 100 may further utilize modification functions. For example, a temperature modification function may comprise: f=a+b(T [symbol] )+c(T [symbol] )+d(T [symbol] )+e(T [symbol] ) [symbol] +f(T [symbol] )(T [symbol] ), where T [symbol] is the indoor web-bulb temperature in degrees F and T [symbol] is the outdoor dry-bulb temperature in degrees F, f may be instantaneous capacity and/or instantaneous EER, and each of a, b, c, d, e and f are polynomial coefficients. Similarly, a flow fraction modification function may comprise: f=x+y(cfm/ton)+z(cfm/ton) [symbol] , where cfm/ton is the indoor airflow per tonnage, f may be instantaneous capacity and/or instantaneous EER, and each of x, y and z are polynomial coefficients. Further, a refrigerant line-set modification function may comprise: f=l+m(length_{ref})+n(length_{ref}) [symbol] , where lengthref is the length of refrigerant line in feet, f may be instantaneous capacity and/or instantaneous EER, and each of l, m, and n are polynomial coefficients. The above-described modification functions are only a few examples of possible functions that may be utilized to model the instantaneous capacity, instantaneous EER, and/or instantaneous power of the HVAC system 100.

Further, while the above-described equations are disclosed as polynomial equations, in alternative embodiments, other equations and mathematical approaches may be utilized in addition to and/or in place of the polynomial equations to account for the HVAC system and/or environmental variables associated with the equations. Alternative engineering equations found in the EnergyPlus Engineering Reference and otherwise available may be utilized to determine instantaneous capacity, instantaneous EER, and/or instantaneous power for the heating mode operation of the HVAC system 100. In some embodiments substantially the same equations may be used for cooling modes and heating modes by applying a set of polynomial coefficient values particular to the cooling mode and a different set of polynomial coefficient values particular to the heating mode. Still further, in alternative embodiments where multi-stage and/or variable/modulating speed/capacity components are utilized, a set of data representing different sets of polynomial coefficient values for a variety of different operating speeds/capacities may be determined in advance and stored for use. For example, a first set of values may be utilized when a variable speed or modulating cooling mode of operation is operating at 50% capacity while a second set of values may be utilized when a variable speed or modulating cooling mode of operation is operating at 100% capacity. An HVAC system operating cost estimate may be generated as a summation of a plurality of calculations of the instantaneous power equations against which sum of the power estimated to have been consumed by the HVAC system 100 an energy cost value may be multiplied to generate a price per power value representative of the HVAC system 100 operation cost estimate.

In some cases, the method 300 may comprise providing energy cost data to the system controller 106. The system controller 106 may automatically poll a local energy provider to retrieve energy cost data. For example, the HVAC system 100 may poll the local energy provider for current electricity costs, and/or energy cost schedules related to peak and off-peak intervals, predicted energy cost data, and/or variable energy cost structures. Alternatively, the system controller 106 may obtain energy cost data from CDP 131, other devices 130, and/or or as a user input through a touch screen interface of system controller 106.

In some embodiments, the HVAC system 100 operation cost estimate may be calculated through the use of a thermodynamic model of the HVAC system 100 and the environment in which the HVAC system 100 is installed. For example, the HVAC system 100 may receive additional various inputs to model the thermodynamic characteristics of the structure 200. The operation of the structure 200 may include opening and closing doors and windows, internal heat inputs due to energy consumption not associated with the HVAC system 100 (e.g. appliances), shading, lighting, and other quantifiable conditions which relate to energy sources and drains to and from the internal structure 200 environment. These inputs may be supplied, for example, by an HVAC system 100 user, an HVAC system 100 installer, an HVAC system 100 manufacturer, ODPs 129, other devices 130, CDPs 131, WDPs 133, and/or combination thereof.

A thermodynamic model of an environment in which HVAC system 100 is installed may be a simple model comprising just a few parameters about structure 200, such as, square footage of controlled climate living space, number of floors, and construction type (brick, log, conventional frame, etc.). A thermodynamic model may be more refined, comprising a three dimensional model of the roof (including surface reflectivity, insulation, pitch, orientation), exterior walls, heat conduction through exterior walls, wall construction, wall surface reflectivity, wall orientation, window placement, window type (including, for example, window properties such as reflectivity, number of glazings, type of glazings, type of gas insulation, age, seals, etc.), doors (materials, type, area, seals, etc.), foundation, effective air leakage rates, air exchange due to normal use of doors and windows, surrounding landscape (mountains, hills, valleys, nearby artificial structures, water, trees, bushes), and/or any other structure 200 data. Further, the thermodynamic model may use a simple or a refined representation of weather. Weather calculations may comprise utilizing a model of sky radiation, cloud cover, solar and shading calculations, radiation reflected from exterior surfaces of structure 200, air and heat balances, ground heat transfer processes, infrared radiation heat exchanges, convective heat exchanges, moisture transfers, wind speed and direction, and/or any other suitable weather related factor.

A thermodynamic model may also utilize real-world information obtained from mapping services such as the United States Geological Service (USGS) or Internet-based services which provide satellite and aerial image data. Images of the property, together with the orientation of the structure 200, surrounding features and topography may be obtained to augment or replace digital photographs provided by the user. Alternatively, construction plans of structure 200 may be utilized to model structure 200.

Once a thermodynamic model of the structure 200 and related surroundings is constructed, the physics of the interactions between the building and the related environment may be modeled at varying levels of detail. In some embodiments, temperatures, solar inputs, wind cooling, and air leakages may be reduced to just a few simple numbers representing averages. The averages may be used in calculations with historic and weather data to calculate the first consumption estimate. In some embodiments, the physics of the structure 200 may be very specific. The thermodynamic model may comprise the location, orientation, thermal resistance value, and reflectivity of each surface of the structure 200 in square inch or square foot units. Solar inputs may be modeled by ray-tracing algorithms. Wind and convective cooling may be modeled by vector fields. Instead of applying heat balance equations to whole walls or windows, each square inch on the surface of the structure 200 may be calculated.

A thermodynamic model which may generate the first consumption estimate may include hourly weather data (or include any available weather data on finer or coarser time-scales), and may rely on historic weather data and energy usage data saved by the system controller 106 or any other suitable recording device on a previous occasion. The calculations may involve interpolating the previous weather data to fit the current weather data. For example if saved weather data includes no contiguous set of days matching the projected forecast (including approximate time of year, which may be useful important for modeling solar inputs), the calculations may assemble non-contiguous periods most closely matching the periods. The model may also assemble close data from a plurality of periods, and interpolate between them. For example, if the weather data indicates a cloudy day in March with a high temperature of 50 degrees F. and low temperature of 40 degrees F., there may be no relevant saved days with that general temperature profile. The modeling may be accomplished by interpolating between two saved cloudy March days, one with a high temperature of 55 degrees F. and low temperature of 45 degrees F., and the other with a high temperature of 45 degrees F. and a low temperature of 35 degrees F. The interpolation may use proportional estimations, or curve fitting as necessary. The interpolation may occur on timescales of quarter hours, hours, days, or any relevant period for which weather data is saved.

In some embodiments, a model may account for semi-interior features of the house, including any attic structure, unheated garage areas, and ventilation of these areas. Attics, garages, three-season rooms and other non-climate controlled areas may provide a buffer region between the climate controlled portions of the home and the non-climate controlled exterior. These areas may be accounted for based on their thermal masses. The areas may comprise HVAC system 100 equipment, duct work, or other household utilities that create a heat load on the system.

The method 300 may continue at block 306 to present the HVAC system 100 operation cost estimate. In some cases, the presentation of the HVAC system 100 operation cost estimate may be conducted via the system controller 106 or any other interface of the HVAC system 100. In other embodiments, one or more of the receiving the HVAC system 100, generating the HVAC system operation cost estimate, and presenting the HVAC system operation cost estimate may be conducted utilizing an interface that is remotely located from the HVAC system 100 and/or not connected to the HVAC system 100. For example, in some embodiments, a website may be provided that is independent of the HVAC system and which is configured to selectively perform one or more of the functions of blocks 302, 304, 306. In some embodiments, the system controller 106 may provide an interface to configure the system controller 106. Alternatively, other devices 130 or a remote access terminal of CDP 131 may provide an interface to configure the system controller 106. The system controller 106 configuration may comprise any relevant setting for an HVAC system 100 such as heating temperature set point, cooling temperature set point, indoor temperature range, indoor relative humidity setpoint, indoor relative humidity range, fresh air exchange rate, circulating fan rates, air filtration power, and/or any other suitable settings. The interface may be, for example, a graphical interface, a touch screen interface, a menu-driven interface, and/or a combination of different types of interfaces. The presentation of the HVAC system 100 operation cost estimate may be accompanied by presentation of the weather data, the current HVAC system 100 settings, the energy cost data (e.g., the current cost of a kilowatt hour), and/or any other appropriate data which may be relevant to the generation of the HVAC system 100 operation cost estimate. The presentation of the HVAC system 100 operation cost estimate may be accomplished using a touch screen display of system controller 106, other devices 130 such as a smart phone, tablet, and/or by a computer logged into CDP 131.

In some embodiments, other devices 130 such as a mobile phone or laptop computer may execute a computer program allowing access to system controller settings 106. HVAC system 100 information may be provided to a mobile phone or to a laptop and energy cost data may be provided to the mobile phone or laptop so that the HVAC system 100 operation cost estimate may be generated by the mobile phone and/or laptop. Alternatively, as described above, one or more of the required actions for generating and/or presenting an HVAC system 100 operation cost estimate may be performed by a remotely located server such as an HVAC system energy consumption calculation server.

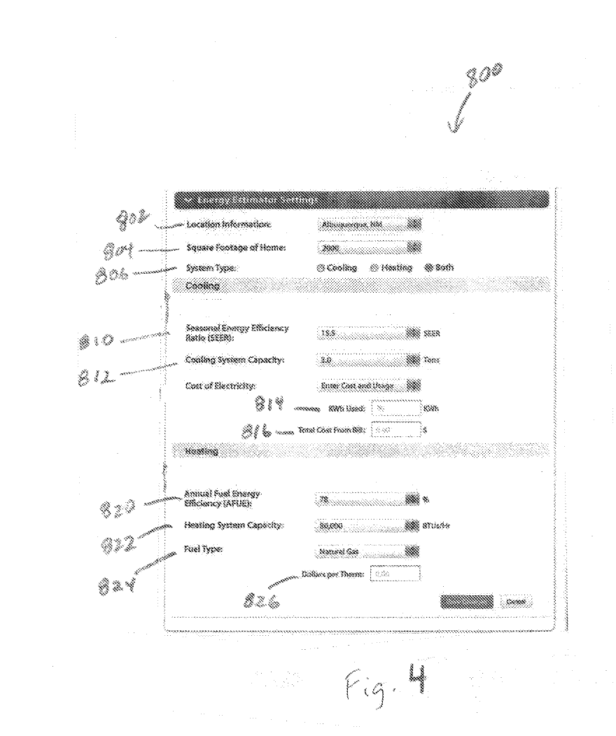

Referring now to FIG. 4, a graphical user interface 800 is provided that is configured to allow a user to input HVAC system 100 information, environmental information, and energy cost information for an HVAC system configured for operating only each of a cooling mode and a heating mode. More specifically, the graphical user interface 800 allows entry of location information 802, square footage of home 804, system type 806, SEER 810, cooling system capacity 812, KWh used 814, total cost from bill 816, annual fuel energy efficiency 820, heating system capacity 822, fuel type 824, and dollars per therm 826. The graphical user interface 800 may be a component of the HVAC system 100 system controller 106, a thermostat, a standalone software program, a remotely located server with a graphical user interface, and/or any other suitable component.

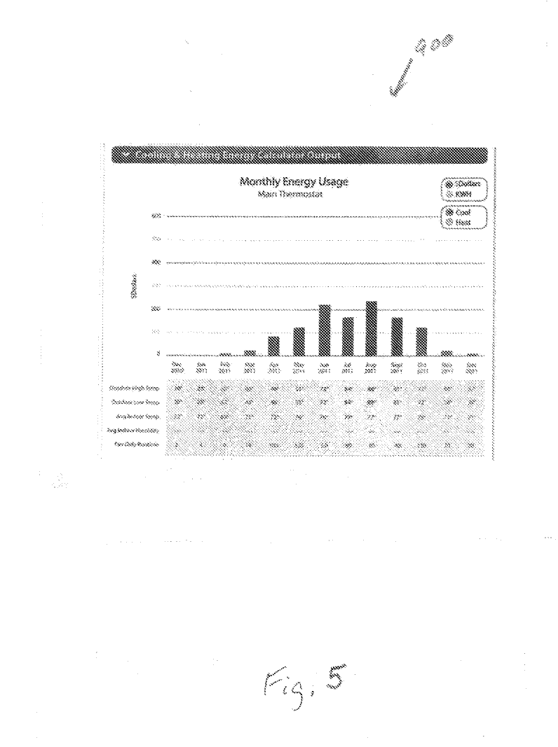

Referring now to FIG. 5, a graphical user interface 900 is provided that is configured to display a summary of cumulative amounts of energy used per month for cooling operation of the HVAC system 100 expressed in dollars per month. In this embodiment, the chart of graphical user interface represents operation of the HVAC system 100 with the monthly average indoor temperature and relative humidity, average outdoor high and low temperature and fan only runtime. In some embodiments, the above-described thermodynamic models may be utilized to determine power consumed by an HVAC system 100 and an HVAC system 100 operation cost estimate per month may be generated and/or presented by determine the cost of the consumed power for each month. In some embodiments, the cost of power may vary over time and the HVAC system and/or other components may record the cost of power and the power consumed in a database to thereafter construct the chart of graphical user interface 900. In some embodiments, the chart of graphical user interface 900 may represent actual historical performance data, while in other embodiments, the chart may represent the power consumed by an ideal or properly functioning HVAC system 100. In alternative embodiments, any other measure of consumption and/or cost and any other units of time may be utilized to display outputs. Still further, in some embodiments, where historical data may not be available to provide a desired time range of outputs, a system may estimate, assume, gather by comparison to similar HVAC systems, utilize historical weather information, and/or otherwise generate projected, presumed, average, and/or any other value to replace missing and/or unavailable historical HVAC system operation information.

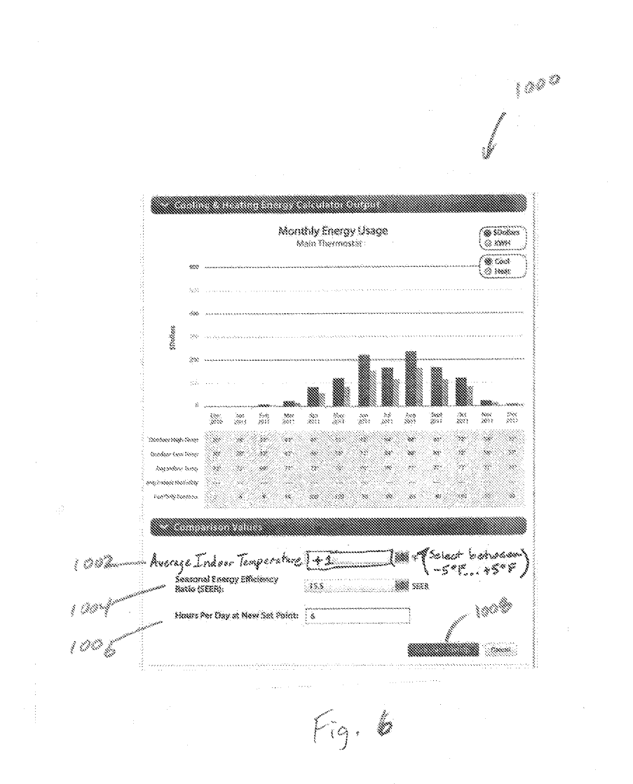

Referring now to FIG. 6, a graphical user interface 1000 is provided that is configured to display a comparison of summaries of cumulative amounts of energy used per month for cooling operation of the HVAC system 100 expressed in dollars per month. The graphical user interface 1000 is configured to receive inputs for comparison average indoor temperature 1002, comparison SEER 1004, and comparison hours per day at new set point 1004. In some embodiments, the comparison average indoor temperature 1002 may be selected as a temperature value within a range of about −10 degrees F. to about +10 degrees F., about −5 degrees F. to about +5 degrees F., and/or any other suitable range for comparison. In some embodiments, selection of the comparison average indoor temperature 1002 may be made by selecting a whole degree increment within a suitable range of temperatures. In some embodiments, a user may input an alternative or proposed comparison average indoor temperature 1002 and a comparison SEER 1004 to display an output indicating comparison hours per day 1006 and a comparative cost chart in response to selecting a calculate savings button 1008. In this embodiment, the chart of graphical user interface 1000 compares (1) the dollars spent per month with the average monthly indoor temperature as shown in the chart of graphical user interface 900 to (2) the dollar spent per month at the average monthly indoor temperature, with SEER held constant. In alternative embodiments, any number of additional or different representations of the comparative costs may be presented. For example, a total yearly cooling operation savings may be presented. In alternative embodiments, the graphical user interfaces 900, 1000 may be configured to generate, display, and/or present cost information related to comparative heating operations and/or both heating and cooling operations. In such cases, the graphical user interfaces 900, 1000 may utilize inputs and/or outputs specific to heating operations and/or fuel types.

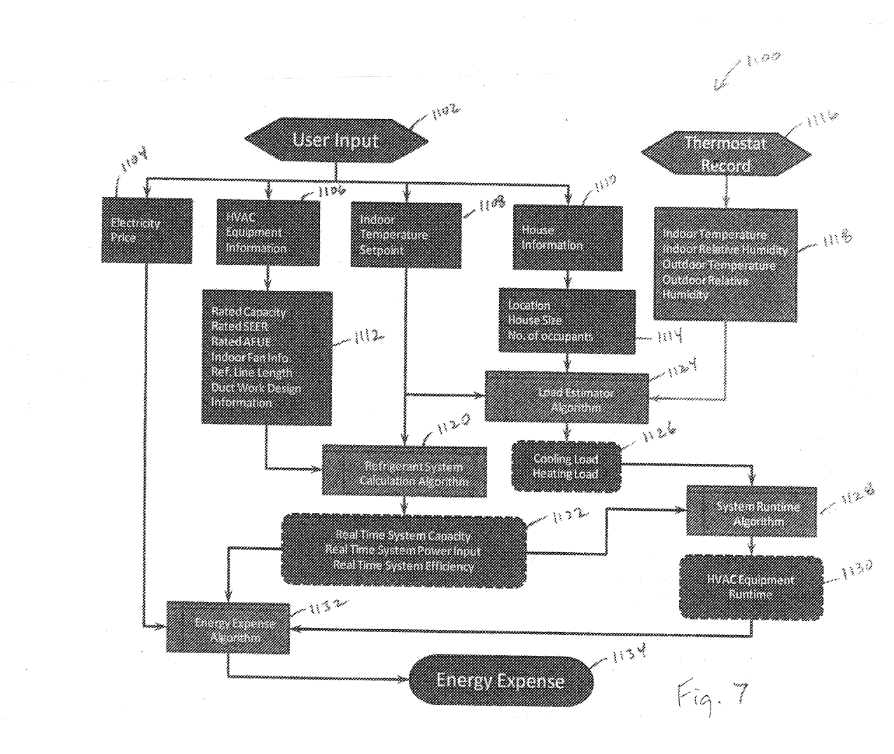

Referring now to FIG. 7, a flowchart of a method 1100 of calculating an energy expense or an HVAC system 100 estimated operation cost is provided. The method 1100 comprises receiving user inputs 1102 regarding electricity price 1104, HVAC equipment information 1106, indoor temperature setpoints 1108, and house information 1110. The HVAC equipment information 1106 may comprise any of a set 1112 of rated capacity, rated SEER, rated AFUE, indoor fan information, refrigerant line length, duct work design information, and/or any other suitable HVAC equipment information. The house information may comprise any of a set 1114 of location, house size, number of occupants, and/or any other suitable house information. The method 1100 further comprises receiving thermostat records 1116 gathered by a thermostat or other controllers. The thermostat records may comprise any of a set 1118 of indoor temperature, indoor relative humidity, outdoor temperature, outdoor relative humidity, and/or any other environmental and/or transient condition that the thermostat may monitor and/or record. The HVAC equipment information and the indoor temperature setpoint information may be used in a refrigerant system calculation algorithm 1120 to calculate a real time or instantaneous system capacity, a real time or instantaneous system power input or consumption, and/or a real time or instantaneous system efficiency, the three of which are collectively labeled 1122, for operation during a single speed cooling mode. The indoor temperature setpoint, the house information, and the information gathered by the thermostat or other controllers may be used in a load estimator algorithm 1124 to calculate a cooling load and/or heating load which are collectively labeled 1126. One or more of the real time or instantaneous system capacity, a real time or instantaneous system power input or consumption, and/or a real time or instantaneous system efficiency and one or more of the cooling load and the heating load may be used in an HVAC system runtime algorithm 1128 to track, record, and/or calculate an HVAC equipment runtime 1130. The electricity price 1104, one or more of the instantaneous system capacity, the instantaneous system power input, and/or the instantaneous system efficiency, and the HVAC equipment runtime 1130 may be used in an energy expense algorithm 1132 to calculate HVAC system energy expense or HVAC system 100 operation cost estimate 1134.

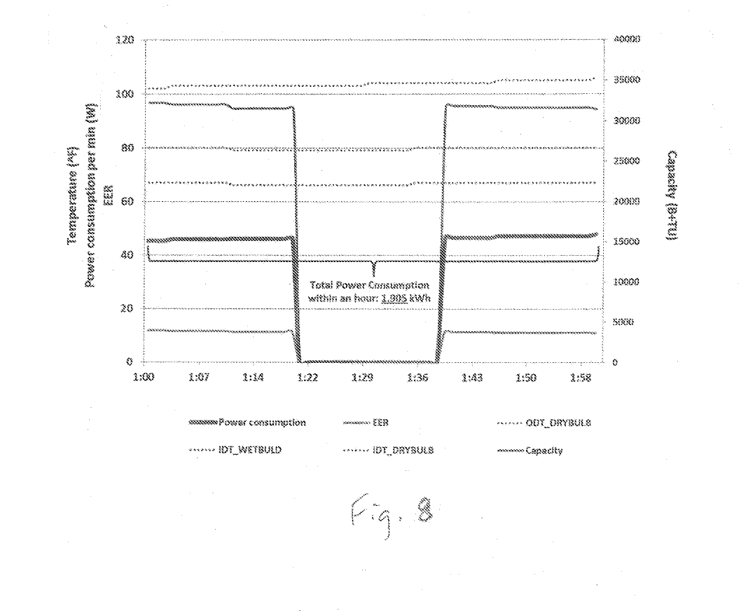

The method 1100 may be utilized, in some embodiments, according to the following example in which an HVAC system 100 is operated solely in a single speed cooling mode of operation. In this example, the following inputs may be provided by a user and/or automatically provided by a component of the HVAC system 100 or by a component in communication with the HVAC system 100: $0.20/KWh, rated capacity of 3 tons, rated SEER of 16, refrigerant line length of 25 ft, cooling setpoint of 75 degrees F., heating setpoint of 65 degrees F., and a house size of 2000 square feet. The thermostat record may provide the following inputs: system mode of single speed cooling, indoor temperature of 80 degrees F., indoor relative humidity of 50%, outdoor temperature of 100 degrees F., and outdoor relative humidity of 80%. The method 1100 may receive rated capacity of 38,000, sensible capacity of 28,100, SEER of 16, EER of 13, and CFM of 1,230 from a user and/or from a personality module of the HVAC system 100. Further, the method 1100 may be provided polynomial coefficient values for each system type combination listed by the Air-Conditioning, Heating, and Refrigeration Institute (AHRI). The polynomial coefficient values may be determined through experiment, simulation, and/or a combination thereof and store and/or made available on components of the HVAC system 100 and/or hardware, servers, and/or devices in selective communication with the HVAC system 100. Different sets of polynomial coefficient values may be provided for calculating instantaneous capacity and instantaneous EER. The method 1000 may monitor and record the above-described variables to generate instantaneous power calculations for discrete periods of time. FIG. 8 is an example chart of monitored and/or calculated values of the following values over a one hour period: indoor wet bulb temperature, indoor dry bulb temperature, outdoor dry bulb temperature, instantaneous capacity, instantaneous EER, and instantaneous power. Subsequently, a total power consumption may be calculated by integrating and/or summing the plurality of recorded instantaneous power consumption values. A total HVAC system 100 operation cost estimate for a period of time may be calculated by multiplying the total power consumption by the cost of electricity and/or fuel.

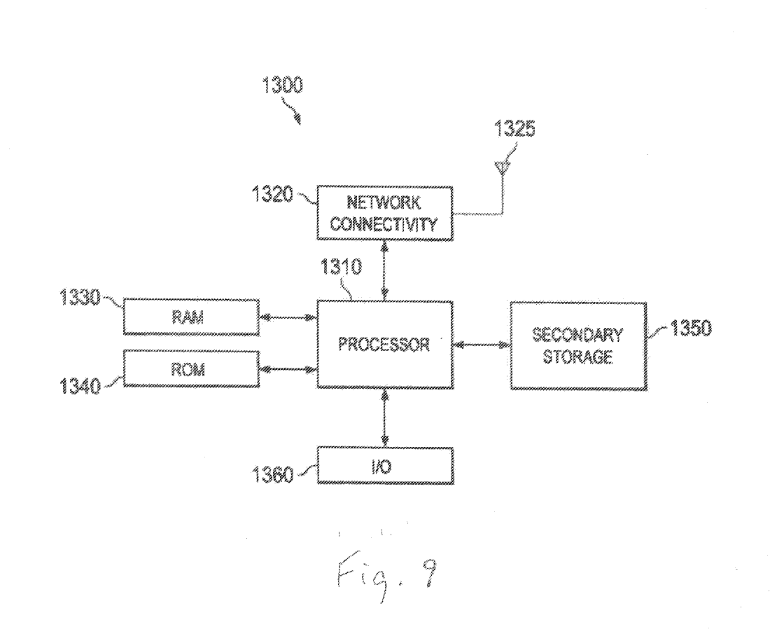

FIG. 9 illustrates a typical, general-purpose processor (e.g., electronic controller or computer) system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, optical disk, or other drive). While only one processor 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs or instructions that are loaded into RAM 1330 when such programs are selected for execution or information is needed.

The I/O devices 1360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 1325 might be considered to be a component of the I/O devices 1360 instead of or in addition to being a component of the network connectivity devices 1320. Some or all of the I/O devices 1360 may be substantially similar to various components disclosed herein.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A method of estimating a cost of operating a heating, ventilation, and/or air conditioning (HVAC) system, comprising:
receiving HVAC system information;
generating at least one of an HVAC system energy consumption estimate and an HVAC system operation cost estimate as a function of the HVAC system information and a thermodynamic model of at least a portion of the HVAC system; and
presenting at least one of the HVAC system energy consumption estimate and the HVAC system operation cost estimate.

2. The method of claim 1, wherein the receiving HVAC system information comprises providing the HVAC system information to a system controller of the HVAC system.

3. The method of claim 1, wherein the generating the at least one of the HVAC system energy consumption estimate and the HVAC system operation cost estimate comprises determining an instantaneous power consumption of the HVAC system.

4. The method of claim 1, wherein the presenting the at least one of the HVAC system energy consumption estimate and the HVAC system operation cost estimate comprises displaying the HVAC system operation cost estimate on a graphical user interface.

5. The method of claim 1, wherein the receiving the HVAC system information comprises providing the HVAC system information to a server located remote from the HVAC system.

6. The method of claim 1, wherein the generating the at least one of the HVAC system energy consumption estimate and the HVAC system operation cost is performed by a server located remote from the HVAC system.

7. The method of claim 1, wherein the generating the at least one of the HVAC system energy consumption estimate and the HVAC system operation cost is performed by a thermostat of the HVAC system.

8. A heating, ventilation, and/or air conditioning (HVAC) system, comprising:
a system controller configured to monitor HVAC system information and environmental conditions associated with operating the HVAC system, wherein the system controller is configured to generate an HVAC system operation cost estimate as a function of the HVAC system information, the environmental conditions, and a thermodynamic model of the HVAC system.

9. The HVAC system of claim 8, wherein the system controller is configured to calculate an instantaneous capacity of the HVAC system.

10. The HVAC system of claim 8, wherein the system controller is configured to calculate an instantaneous energy efficiency rating of the HVAC system.

11. The HVAC system of claim 8, wherein the system controller is configured to calculate an instantaneous power consumption of the HVAC system.

12. The HVAC system of claim 8, wherein the HVAC system information comprises an HVAC system mode of operation.

13. The HVAC system of claim 8, wherein the environmental conditions comprise an indoor temperature and an outdoor temperature.

14. The HVAC system of claim 8, wherein the environmental conditions comprise a relative humidity.

15. The HVAC system of claim 8, further comprising:
a remote server configured to generate at least one of an HVAC system energy consumption estimate and an HVAC system operation cost estimate as a function of the HVAC system information, the environmental conditions, and a thermodynamic model of the HVAC system instead of the system controller.

16. The HVAC system of claim 8, further comprising:
a graphical user interface located remote from the system controller, the graphical user interface being configured to selectively present at least one of an HVAC system energy consumption estimate and an HVAC system operation cost estimate as a function of the HVAC system information, the environmental conditions, and a thermodynamic model of the HVAC system.

17. The HVAC system of claim 8, wherein the system controller is configured to selectively present the HVAC system operation cost estimate.

18. A system controller for a heating, ventilation, and/or air conditioning (HVAC) system, wherein the system controller is configured to generate an HVAC system instantaneous power consumption as a function of HVAC system information and a thermodynamic model of the HVAC system.

19. The system controller of claim 18, wherein the system controller is a thermostat located local to a residence associated with the HVAC system and wherein the thermostat is configured to present at least one of an HVAC energy consumption estimate and an HVAC system operation cost estimate as a function of the HVAC system instantaneous power consumption.

20. The system controller of claim 18, wherein the system controller is a server located remote from a residence associated with the HVAC system and wherein the server is configured to provide at least one of an HVAC energy consumption estimate and an HVAC system operation cost estimate as a function of the HVAC system instantaneous power consumption.
